(19) United States
(12) Patent Application Publication
(10) Pub. No.: US 2002/0153490 A1
(43) Pub. Date: Oct. 24, 2002

(54) Concentration detection system

(76) Inventor: Robert O'Leary, Newton, MA (US)

Correspondence Address: IANDIORIO & TESKA, ONTELLECTUAL PROPERTY LAW ATTORNEYS, 260 BEAR HILL ROAD, WALTHAM, MA, 02451-1018, US

(21) Appl. No.: 10/108,957

(22) Filed: Mar. 28, 2002

Related U.S. Application Data
(60) Provisional application No. 60/279,522, filed on Mar. 28, 2001.

(51) Int. Cl. G01N 21/61

(52) U.S. Cl. 250/353; 250/343

(57) ABSTRACT

A concentration detection system with a radiation source device which outputs a collimated beam of radiation across a sample path having an unknown concentration of fluid of interest and a detector device including a sample sensor, a reference sensor, and an integrating lens positioned to integrate the collimated radiation passing through the sample path evenly over the sample sensor and the reference sensor so that the instantaneous fields of view of the sample sensor and the reference sensor are the same to equalize any obscurations effects thereof.

### RELATED APPLICATIONS

This invention claims priority of Provisional Patent Application Serial No. 60/279,522 filed Mar. 28, 2001.

### FIELD OF THE INVENTION

This invention relates to a fluid concentration detection system, one particular species of which is a CO₂ gas analyzer.

### BACKGROUND OF THE INVENTION

Fluid (gas and liquid) concentration detection systems, such as CO₂ gas analyzers, are often used in the medical field and typically output a signal indicative of the concentration of a designated fluid in a sample being monitored by the system.

In U.S. Pat. No. 5,616,923, incorporated herein by this reference, a CO₂ analyzer is disclosed including an emitter which directs a collimated beam of infrared radiation through a sample cell containing a gas sample and a detector including a “data” sensor and a reference sensor.

Infrared energy in a species specific band is absorbed by the gas of interest in the sample cell to an extent proportional to the concentration of that gas. Thereafter, the attenuated beam is directed to both the data sensor and the reference sensor. Band pass filters in front of those sensors limit the energy reaching them to specified and different bands. Each of the sensors then outputs an electrical signal proportional in magnitude to the intensity of the energy striking that sensor. These signals are amplified and ratioed to determine the concentration of the gas being monitored.

In order for this signal to truly reflect the concentration of the gas being monitored, the same attenuated beam must be directed to both the data sensor and the reference sensor since the beam is attenuated not only by the gas of interest but also by obscurants, e.g., particles such as water particles present on the various optical components of the system.

To this end, the '923 patent proposes the use of a beam splitter which directs the same attenuated beam equally to both the data sensor and the reference sensor.

The problems associated with the use of a beam splitter, however, are many. First, the size of the apparatus must be large enough to accommodate the beam splitter and the two discrete beam paths and the discrete sensors. Second, the beam splitter itself is an expensive component. Third, care must be taken to correctly and precisely align the optical components including the beam splitter. Fourth, because the two sensors must be discreet, they must be fairly large which requires more power, provides less sensitivity, and induces more noise. Fifth, heaters must be used to keep both sensors at the same temperature.

### SUMMARY OF THE INVENTION

It is therefore an object of this invention to provide a concentration detection system which eliminates the need for a beam splitter.

It is a further object of this invention to provide such a concentration detection system which can be made very small and compact.

It is a further object of this invention to provide such a concentration detection system which is less expensive to manufacture.

It is a further object of this invention to provide such a concentration detection system in which there are no strict precise alignment requirements for the optical components of the system.

It is a further object of this invention to provide such a concentration detection system which allows the sensors to be placed adjacent each other on the same plane, and allows the sensors to be made fairly small.

It is further object of this invention to provide such concentration detection system which requires less power to operate than prior art concentration detection systems.

It is a further object of this invention to provide a higher sensitivity concentration detection system.

It is a further object of this invention to provide such a concentration detection system which reduces the noise associated with prior art concentration detection systems.

It is a further object of this invention to provide such a concentration detection system which does not require heaters to keep both the sensors at the same temperature.

It is a further object of this invention to provide, in one embodiment, a CO₂ gas analyzer type concentration detection system.

This invention results from the realization that the need for and the problems associated with a beam splitter in CO₂ gas analyzers and other fluid concentration detection systems can be eliminated by the use of an integrating lens in the detector positioned to integrate the collimated radiation passing through a sample path evenly over a sample sensor and a reference sensor so that the instantaneous fields of view of the sample sensor and the reference sensor are the same to equalize any obscuration effects thereof to thus provide a more compact, less expensive, lower power, highly sensitive fluid concentration detection system.

This invention features a concentration detection system comprising a radiation source device which outputs a collimated beam of radiation across a sample path having an unknown concentration of fluid of interest and a detector device including a sample sensor, a reference sensor, and an integrating lens positioned to integrate the collimated radiation passing through the sample path evenly over the sample sensor and the reference sensor so that the instantaneous fields of view of the sample sensor and the reference sensor are the same to equalize any obscurations effects thereof.

In the preferred embodiment, the source device includes a radiation source and a collimating lens which forms the collimated beam. The collimating lens is preferably positioned at a distance from the radiation source such that the radiation source is completely imaged by the collimating lens. The collimating lens typically has a focal length greater than the distance between the collimating lens and the radiation source. The radiation source may be an infrared radiation producing filament and the collimating lens may be one half of a sapphire ball lens, the flat surface of which faces the radiation source.

The integrating lens of the detector device is preferably positioned at a distance from the sample sensor and the reference sensor such that the sample sensor and the reference sensor are both completely imaged by the integrating lens. The integrating lens then has a focal length greater than the distance between the integrated lens and the sample and reference sensors. In one example, the integrating lens is one half of a sapphire ball lens, the flat surface of which faces the sample and reference detectors.

In one example, the radiation source includes a header, a filament supported above the header, a can mated with the header and including an aperture therein, and a collimating lens positioned in the can between the filament and the aperture. In the same example, the detector includes a header having the reference sensor and the sample sensor mounted thereon adjacent each other. A filter pack is disposed above the reference and sample sensors and a can is mounted with the header and includes an aperture therein. The integrating lens is positioned in the can between the aperture therein and the filter pack.

One concentration detection system in accordance with this invention includes a radiation source device which outputs a collimated beam of radiation across a sample path having an unknown concentration of fluid of interest and a detector device including a sample sensor, a reference sensor positioned adjacent the sample sensor and lying in the same plane as the sample sensor, and an integrating lens positioned to integrate the collimated radiation passing through the sample path evenly over the sample sensor and the reference sensor.

### BRIEF DESCRIPTION OF THE DRAWINGS

Other objects, features and advantages will occur to those skilled in the art from the following description of a preferred embodiment and the accompanying drawings, in which:

FIG. 1 is a simplified block diagram shown in the primary component associated with a prior art CO₂ gas analyzer;

FIG. 2 is simplified block diagram showing the primary components associated with the prior art CO₂ gas analyzer disclosed in U.S. Pat. No. 6,616,923;

FIG. 3 is a simplified block diagram showing the primary components associated with one embodiment of the fluid concentration detection system of the subject invention;

FIG. 4 is a schematic cross-sectional view showing the preferred radiation source for the concentration detection system of the subject invention;

FIG. 5 is an exploded schematic view showing, in the preferred embodiment, the detector of the concentration detection system of the subject invention;

FIG. 6 is a view showing a complete CO₂ gas analyzer type concentration detection system in accordance with the subject invention; and

FIG. 7 is a view similar to FIG. 6 showing a sample cell in place in the exemplary concentration detection system of the subject invention.

### DISCLOSURE OF THE PREFERRED EMBODIMENT

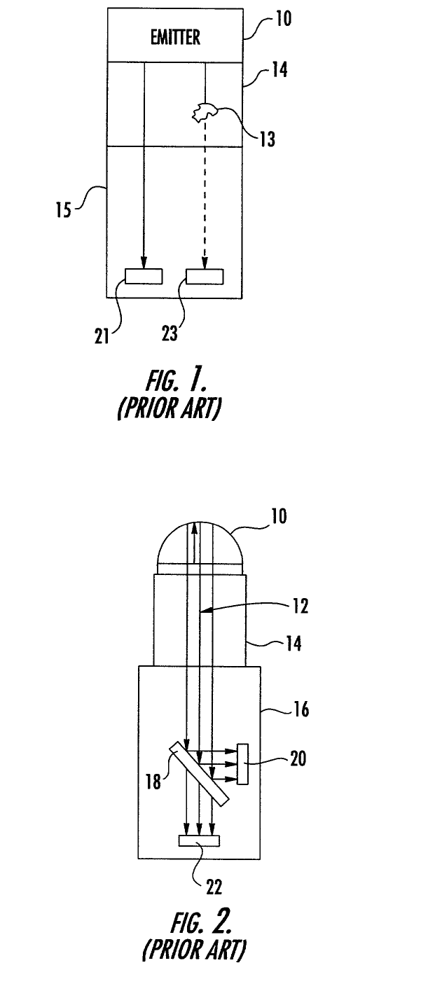

FIG. 1 shows the primary components associated with a prior art gas analyzer: emitter 10, sample cell 14, and detector device 15 including detectors 21 and 23. Detector 21 may be the “data” sensor and detector 23 the reference detector. In this design, however, obscurant 13 in sample cell 14 attenuates the beam incident on reference detector 23. When this happens, the concentration measurement is adversely affected since the ratio of the signal from reference detector 23 and the signal from data sensor 21 is not truly representative of the concentration of the gas in sample cell 14 due to obscurant 13. Thus, the design of FIG. 1 suffers from obscuration effects as known by those skilled in the art.

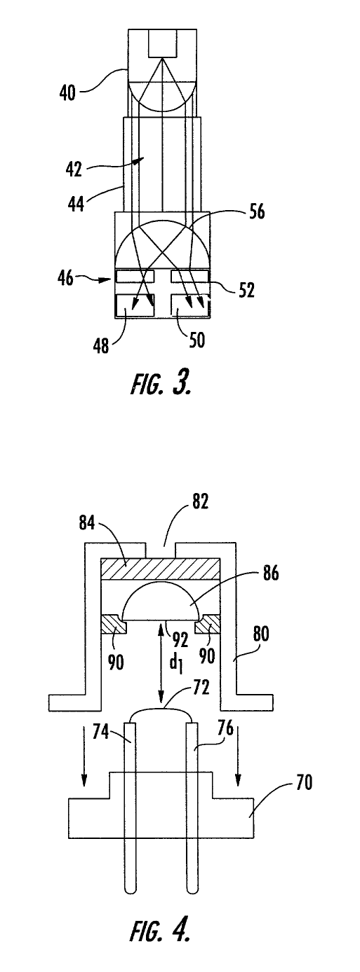

As also explained above, FIG. 2 is an extremely simplified block diagram of the gas analyzer shown in the '923 patent. Emitter 10 produces a collimated beam 12 of infrared radiation which passes through sample cell 14 containing a gas to be analyzed and thereafter into detector 16 which includes beam splitter 18 for directing beam 12 to detectors 20 and 22—one of which is a reference sensor or detector; the other of which is a “data” sensor or detector.

As discussed in the background section above, beam splitter 18 is required because the same attenuated beam must be directed to both the data sensor and the reference sensor in order for the output signal of the device to truly reflect the concentration of the gas being monitored since the beam is attenuated not only by the gas of interest but also by obscurants, for example particles such as water particles present on the various optical components of the gas analyzer. Thus, the design of FIG. 2 does not suffer from obscuration effects, but, beam splitter 18 also mandates that the size of the gas analyzer be large enough to accommodate not only the beam splitter but the two discrete beam paths formed thereby. Moreover, the beam splitter itself is an expensive component and care must be taken to correctly and precisely align all of the optical components including the beam splitter. Because sensors 20 and 22 must be discrete, they are also fairly large which requires more power to operate them. In addition, the larger size sensors result in less sensitivity and more noise. Finally, heaters must be used to keep both sensors 20 and 22 at the same temperature. See the '923 patent, Col. 6, line 59-Col. 7, line 2.

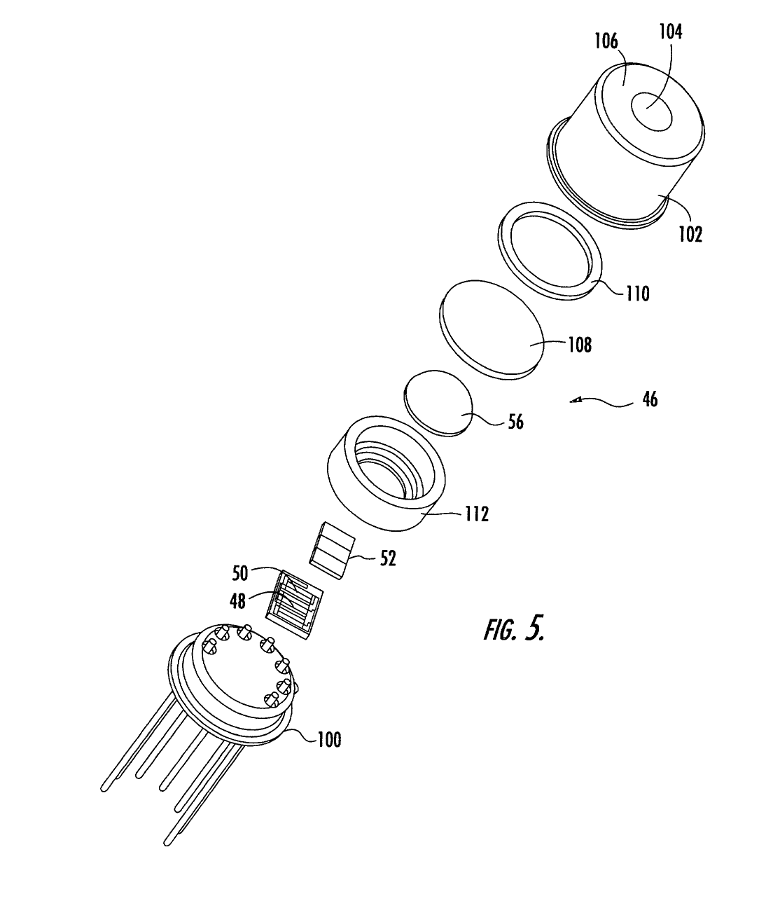

In the subject invention, the need for and problems associated with beam splitter 18, FIG. 2 are eliminated and yet any obscuration effects are minimal. Infrared emitter or other radiation source device 40, FIG. 3, in accordance with this invention, produces collimated beam 42 which passes through sample cell 44 having an unknown concentration of a fluid of interest (e.g., CO₂ gas).

Detector device 46 includes sample sensor 48 and reference sensor 50 (and, optionally, a “blind” sensor) below filter pack 52. A blind sensor is used for dark current subtraction and to adjust for thermal drifting when a chopped source is not used. Integrating lens 56 is positioned to integrate the collimated radiation passing through the sample path evenly over sample sensor 48 and reference sensor 50 so that the instantaneous fields of view of sample sensor 48 and reference sensor 50 are the same to equalize any obscuration effects.

But, since no beam splitter is required and since sample sensor 48 and reference sensor 50 can be placed adjacent to each other to lie in the same plane as shown in FIG. 3, the result is a less costly concentration detection system which also requires less power to operate. The resulting concentration detection system can also be made more compact in part because heaters are not required to keep sensors 48 and 50 at the same temperature: they naturally are maintained at the same temperature because they are in close proximity to each other. The resulting concentration detection system can also be made much more compact because two separate discreet beam paths are not required. Furthermore, there are no strict requirements regarding precise alignment of the various optical components of the system.

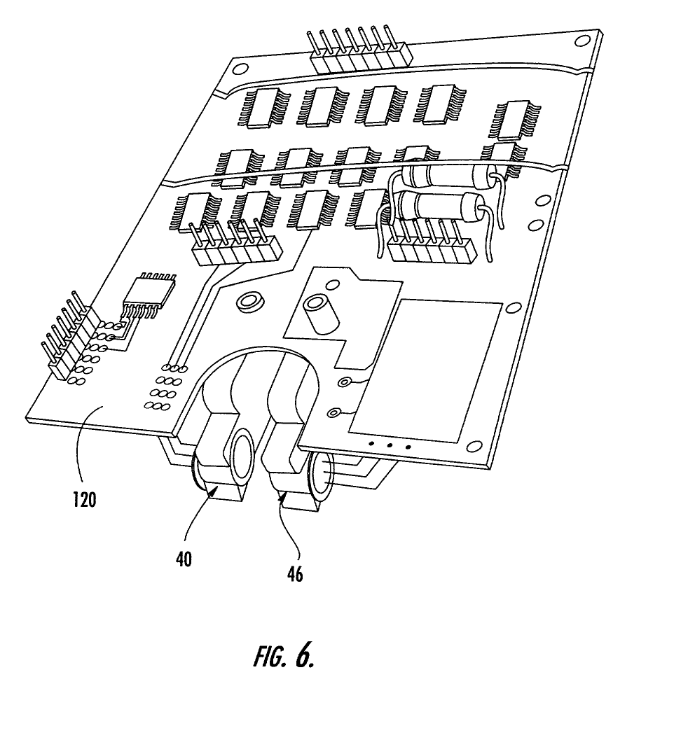

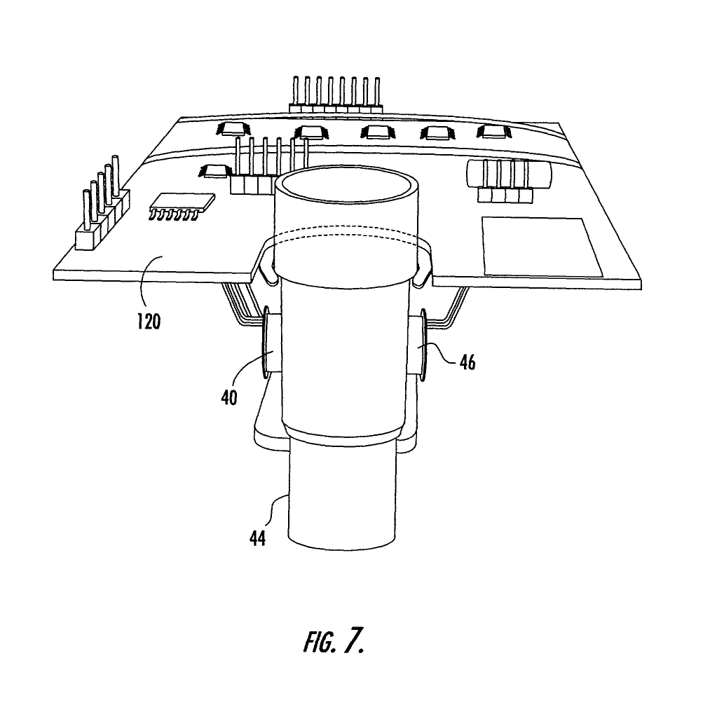

The preferred infrared emitter is shown in FIG. 4. One specific example of the detector device is shown in FIG. 5. FIGS. 6 and 7 are views showing a complete concentration detection system incorporating the emitter of FIG. 4 and the detector device of FIG. 5.

Preferred infrared radiation source device 40, FIG. 4 includes TO type header 70, and 0.070 inch long by 0.070 inch wide serpentine infrared radiation producing tungsten filament 72 supported above header 70 by electrodes 74 and 76 connected to a power source (not shown). The impedance (e.g., 9 ohms) of filament 72 is optimally designed to match the impedance of the power source connected to electrodes 74 and 76. TO can 80 is mated and hermetically sealed with respect to header 70 and includes aperture 82 in the top thereof as shown. Optional sapphire window element 84 seals aperture 82 with respect to TO can 80. Collimating lens 86 is positioned between filament 72 and aperture 82 and at a distance d₁ from filament 72 such that filament 72 is completely imaged by collimating lens 86. Collimating lens 86 is held in place inside TO can 80 via holder 90. In one example, distance d₁ was 60 mils. In the same example, collimating lens 86 was one half of a sapphire ball lens and had a focal length slightly greater than distance d₁. As shown, flat surface 92 of the half ball lens faces filament 72 to collimate the infrared radiation produced thereby for transmission out of aperature 82 and through a cuvette or other sample path. Other applicable radiation source devices include the emitter shown in the '923 patent as well as filament and arc gap type radiation producers incorporating an optical element or elements which, at least to some extent, collimate the radiation. Examples of applicable optical elements include the use of a reflector or a plano convex lens.

In the preferred embodiment, the other half of the sapphire ball lens is used as integrating lens 56, FIG. 5 of detector device 46. Detector device 46, in this example, includes TO header 100 having reference sensor 50 and sample sensor 48 mounted adjacent each other thereon. Filter pack 52 is located right above the sensors. TO can 102 is hermetically sealed with respect to header 100 and includes aperture 104 in top surface 106 thereof which receives the attenuated collimated beam after it passes through the sample path containing the gas of interest. Inside TO can 102 is sapphire window 108 behind seal 110 which seals aperture 104 with respect to can 102. Behind window 108 is integrating lens 56 held in place by lens holder 112 between aperture 104 and filter pack 52.

The adjacent active areas of PbSe sensors 48 and 50 conveniently lie in the same plane and integrating lens 56 is positioned at a distance thereof such that both sample 48 and reference 50 sensors are completely imaged by integrating lens 56. Preferably, the focal length of integrating lens 56 is slightly greater than the distance between integrating lens 56 and the sample and reference detectors. As shown, the flat surface of the half ball lens faces the sample and reference detectors.

In other embodiments, the filter materials (coatings) and the sensors may be configured as set forth in the '923 patent or as known in the art. The preferred detectors and filter pack assembly, however, are available from PerkinElmer Optoelectronics, Salem, Mass.

In FIG. 6, detector device 46 of FIG. 5 and emitter device 40 of FIG. 4 are shown mounted to printed circuit board 120 which includes the electronic components necessary to drive emitter device 40 and the signal processing functionality associated with detector 46.

In FIG. 7, sample cell 44 is shown in place between the respective apertures of emitter 40 and detector 46. The details of printed circuit board 120 and cuvette 44 are not provided as neither forms the basis for the claims of this patent. Instead, FIGS. 6 and 7 are presented to show the compact size of the concentration detection system of the subject invention attributable in part to the lack of or need for a beam splitter. Because of this feature, small 0.3 inch in diameter, 0.5 inch long TO cans and headers can be used as the housings for both the emitter and the detector. Indeed, arrays of emitters and detectors can be employed to monitor different fluids including different types of gasses. Collimating lens 86, FIG. 4 and integrating lens 56, FIG. 5, which is positioned to integrate the collimated radiation passing through a sample path evenly over the sample sensor and the reference sensor so that the instantaneous fields of view of the sample sensor and the reference sensor are the same, equalizes any obscuration effects. This configuration provides a more compact, less expensive, and lower power, fluid concentration system with increased sensitivity.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims.

What is claimed is:

1. A concentration detection system comprising:
a radiation source device which outputs a collimated beam of radiation across a sample path having an unknown concentration of fluid of interest; and
a detector device including:
a sample sensor,
a reference sensor, and
an integrating lens positioned to integrate the collimated radiation passing through the sample path evenly over the sample sensor and the reference sensor so that the instantaneous fields of view of the sample sensor and the reference sensor are the same to equalize any obscurations effects thereof.

2. The concentration detection system of claim 1 in which the source device includes:
a radiation source; and
a collimating lens which forms the collimated beam.

3. The concentration detection system of claim 2 in which the collimating lens is positioned at a distance from the radiation source such that the radiation source is completely imaged by the collimating lens.

4. The concentration detection system of claim 3 in which the collimating lens has a focal length greater than the distance between the collimating lens and the radiation source.

5. The concentration detection system of claim 2 in which the radiation source is an infrared radiation producing filament.

6. The concentration detection system of claim 2 in which the collimating lens is one half of a ball lens, the flat surface of which faces the radiation source.

7. The concentration detection system of claim 6 in which the collimating lens is made of sapphire.

8. The concentration detection system of claim 1 in which the integrating lens is positioned at a distance from the sample sensor and the reference sensor such that the sample sensor and the reference sensor are both completely imaged by the integrating lens.

9. The concentration detection system of claim 8 in which the integrating lens has a focal length greater than the distance between the integrated lens and the sample and reference sensors.

10. The concentration detection system of claim 1 in which the integrating lens is one half of a ball lens, the flat surface of which faces the sample and reference detectors.

11. The concentration detection system of claim 10 in which the integrating lens is made of sapphire.

12. The concentration detection system of claim 1 in which the radiation source includes a header, a filament supported above the header, a can mated with the header and including an aperture therein, and a collimating lens positioned in the can between the filament and the aperture.

13. The concentration detection system of claim 1 in which the detector includes a header having the reference sensor and the sample sensor mounted thereon adjacent each other, a filter pack above the reference and sample sensors, and a can mounted with the header and including an aperture therein, the integrating lens positioned in the can between the aperture therein and the filter pack.

14. A concentration detection system comprising:
a radiation source device which outputs a collimated beam of radiation across a sample path having an unknown concentration of fluid of interest; and
a detector device including:
a sample sensor,
a reference sensor positioned adjacent the sample sensor and lying in the same plane as the sample sensor, and
an integrating lens positioned to integrate the collimated radiation passing through the sample path evenly over the sample sensor and the reference sensor.

15. A concentration detection system comprising:
a radiation source device including a radiation source and a collimating lens which forms a collimated beam of radiation output across a sample path having an unknown concentration of fluid of interest; and
a detector device including:
a sample sensor,
a reference sensor, and
an integrating lens positioned to integrate the collimated radiation passing through the sample path evenly over the sample sensor and the reference sensor.

16. A concentration detection system comprising:
a radiation source device including a collimating one half ball lens which outputs a collimated beam of radiation across a sample path having an unknown concentration of fluid of interest; and
a detector device including:
a sample sensor,
a reference sensor, and
an integrating one half ball lens positioned to integrate the collimated radiation passing through the sample path evenly over the sample sensor and the reference sensor so that the instantaneous fields of view of the sample sensor and the reference sensor are the same to equalize any obscurations effects thereof.

17. A concentration detection system comprising:
a radiation source device including a collimating lens positioned at a distance from a radiation source such that the radiation source is completely imaged by the collimating lens, collimating lens having a focal length greater than the distance between the collimating lens and the radiation source to output a collimated beam of radiation across a sample path having an unknown concentration of fluid of interest; and
a detector device including:
a sample sensor,
a reference sensor, and
an integrating lens positioned at a distance from the sample sensor and the reference sensor such that the sample sensor and the reference sensor are both completely imaged by the integrating lens, the integrating lens having a focal length greater than the distance between the integrated lens and the sample and reference sensors to integrate the collimated radiation passing through the sample path evenly over the sample sensor and the reference sensor so that the instantaneous fields of view of the sample sensor and the reference sensor are the same to equalize any obscurations effects thereof.

18. A concentration detection system comprising:
a radiation source device including:
a header,
a filament supported above the header,
a can mated with the header and including an aperture therein, and
a collimating lens positioned in the can between the filament and the aperture which outputs a collimated beam of radiation across a sample path having an unknown concentration of fluid of interest; and
a detector device including:
a header having a reference sensor and a sample sensor mounted thereon adjacent each other,
a filter pack above the reference and sample sensors,
a can mounted with the header and including an aperture therein, and
an integrating lens positioned in the can between the aperture therein and the filter pack to integrate the collimated radiation passing through the sample path evenly over the sample sensor and the reference sensor so that the instantaneous fields of view of the sample sensor and the reference sensor are the same to equalize any obscurations effects thereof.
